(19) United States
(12) Patent Application Publication
(10) Pub. No.: US 2012/0067653 A1
(43) Pub. Date: Mar. 22, 2012

(54) STEERING DOLLY

(75) Inventors: Robert A. Mallett, Mitchell, SD (US); Chris D. Williams, Plankinton, SD (US)

(73) Assignee: TRAIL KING INDUSTRIES, INC., Mitchell, SD (US)

(21) Appl. No.: 12/885,666

(22) Filed: Sep. 20, 2010

(51) Int. Cl. B62D 11/04

(52) U.S. Cl. 180/6.5; 180/6.48

(57) ABSTRACT

A dolly includes a frame having a load deck for supporting a load and a plurality of axles coupled to the frame in a generally parallel relationship with wheels rotationally coupled to each side of the axles. Independent drive motors are operatively connected to each of the wheels such that the wheels can be driven completely independently from each other. This independent rotation enables the dolly to rotate in place about a vertical axis as well as minimize a turning radius of the dolly in a skid steer operation.

### TECHNICAL FIELD

This invention relates to a dolly for carrying a load, and more specifically to improved steering systems for such a dolly.

### BACKGROUND

Dollies such as steering dollies and beam dollies are traditionally used to provide primary or supplemental support for a load. Conventional dollies include three or more axles having wheels that may be driven together by a steering system to move the load. One type of conventional steering system includes a turn table bearing for each pair of wheels on an axle. Another type of conventional steering system includes a caster-steer type axle. Each of these conventional steering systems imposes rotational limits on the independent movement of the wheels because linkages and similar components connected to the wheels and axles block further rotation after a certain degree of turning. As a result, the dolly has a relatively large minimum turning radius that may negatively affect the control and positioning of a dolly in tight confines or underneath a load. This large minimum turning radius is especially problematic when multiple dollies are used in conjunction to support and move an elongate item.

Consequently, it would be desirable to provide a dolly with a steering system that addresses these and other problems of conventional dollies.

### SUMMARY

A dolly according to one embodiment of the present invention includes a frame with a load deck for supporting a load. The dolly also includes a plurality of axles coupled to the dolly in a generally parallel relationship having wheels coupled there to. The dolly also includes independent drive motors operatively connected to each of the wheels. The drive motors enable the wheels to be rotated completely independently from each other.

In this embodiment, the load deck is coupled to a rotatable platform carried by the frame of the dolly. The rotatable platform includes an aperture configured to engage a locking member on the frame to selectively lock the load deck in a desired rotational position. The dolly also includes a control system for actuating each of the independent drive motors. In one example, the control system actuates the drive motors along one side of the frame while keeping the drive motors along opposite side of the frame inactive to enable skid-steer turning of the dolly. In another example, the control system actuates the drive motors along one side of the frame in a first direction and the drive motors along the opposite side of the frame in a second direction opposite to the first direction such that the dolly rotates about a vertical axis of the frame. Consequently, the control system and individual drive motors minimize the turning radius of the dolly and maximize the range of motion for the dolly.

In another embodiment, a method of steering a dolly is provided. The dolly again includes a frame with a plurality of axles and wheels rotatably coupled to the plurality of axles. The method includes coupling an individual drive motor to each of the wheels, and actuating the drive motors to drive at least one of the wheels of the dolly independently from the other wheels. The dolly may include a load deck, and actuating the drive motors enables the frame of the dolly to be rotated with respect to the load deck. The drive motors are hydraulic motors in one embodiment, but the drive motors may also be electric motors or other types of motors for driving an individual wheel.

### BRIEF DESCRIPTION OF THE DRAWINGS

The accompanying drawings, which are incorporated in and constitute a part of this specification, illustrate an embodiment of the invention and, together with a general description of the invention given below, serve to explain the principles of the invention.

FIG. 1 is a perspective view of one embodiment of a dolly including a steering system according to the invention.

FIG. 2 is a bottom view of the dolly of FIG. 1.

FIG. 3 is an elevation view of the dolly of FIG. 1 in cross-section.

FIG. 4A is a detail elevation view of the locking arrangement of the dolly of FIG. 1 in a locked position.

FIG. 4B is a detail elevation view of the locking arrangement of the dolly of FIG. 1 in an unlocked position.

FIG. 5 is a perspective view of the dolly of FIG. 1, illustrating the rotation of the load deck with respect to the frame.

FIG. 6 is a top view of the dolly of FIG. 1, in a first rotational position.

FIG. 7 is a top view of the dolly of FIG. 1, in a second rotational position.

FIG. 8 is a top view of the dolly of FIG. 1, in a third rotational position.

### DETAILED DESCRIPTION

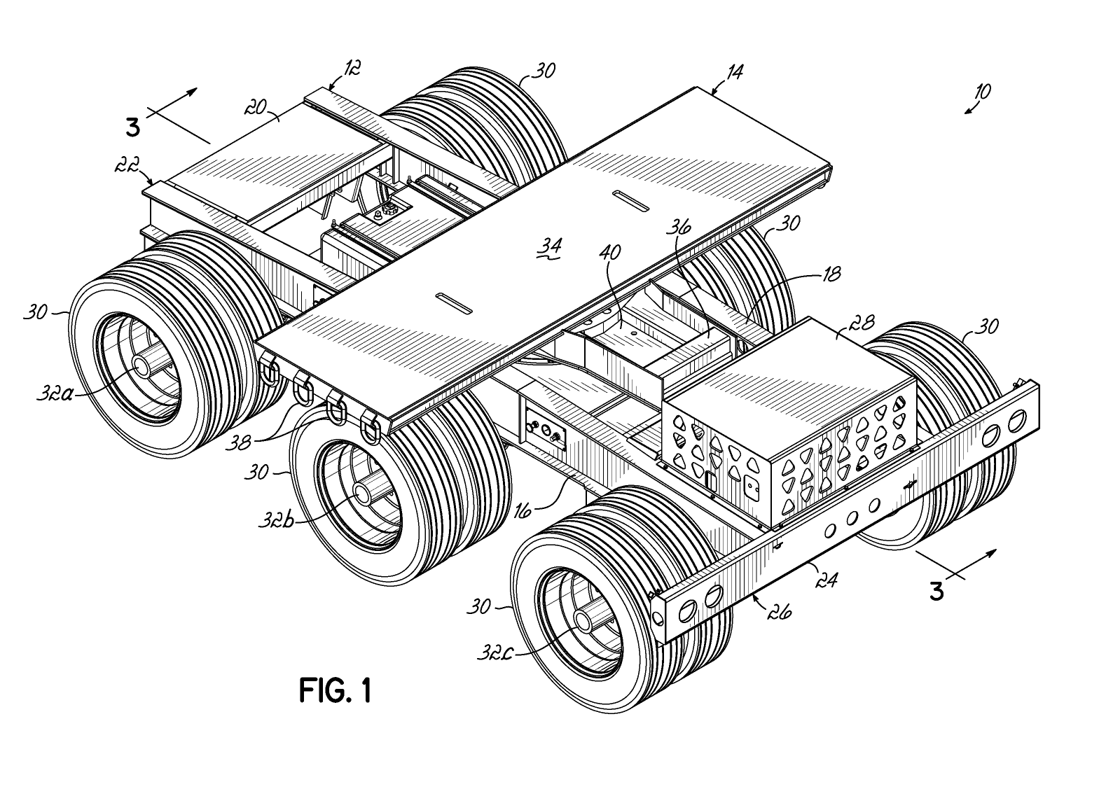

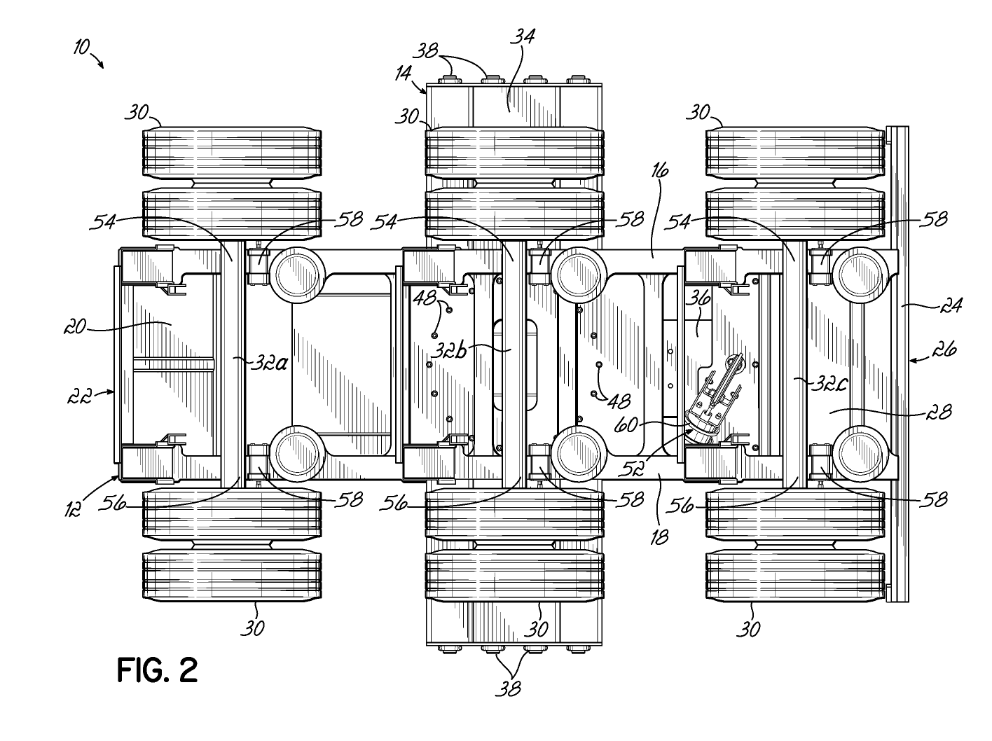

FIGS. 1-8 illustrate an exemplary embodiment of a dolly 10 according to the invention. The dolly 10 may be a steering dolly or a beam dolly that is self-driven as is well understood in the art, but the concepts of this disclosure are not limited to a particular type of dolly 10. As shown in FIGS. 1 and 2, the dolly 10 includes a frame 12 and a load deck 14 coupled to the frame 12. The load deck 14 is configured to support a load such as structural beams, construction containers, and other items. The frame 12 includes first and second side members 16, 18 coupled to a front frame member 20 at a front end 22 of the dolly 10. The first and second side members 16, 18 are formed from structural I-beams formed from steel or a similar material. The first and second side members 16, 18 extend generally parallel along a longitudinal direction of the dolly 10 from the front frame member 20 to a rear fender 24 at a rear end 26 of the dolly 10. The rear fender 24 extends transverse to the longitudinal direction beyond the first and second side members 16, 18. The frame provides a structural connection between the load deck 14, a control box 28, and a plurality of wheels 30 mounted on a plurality of axles 32, as described in further detail below.

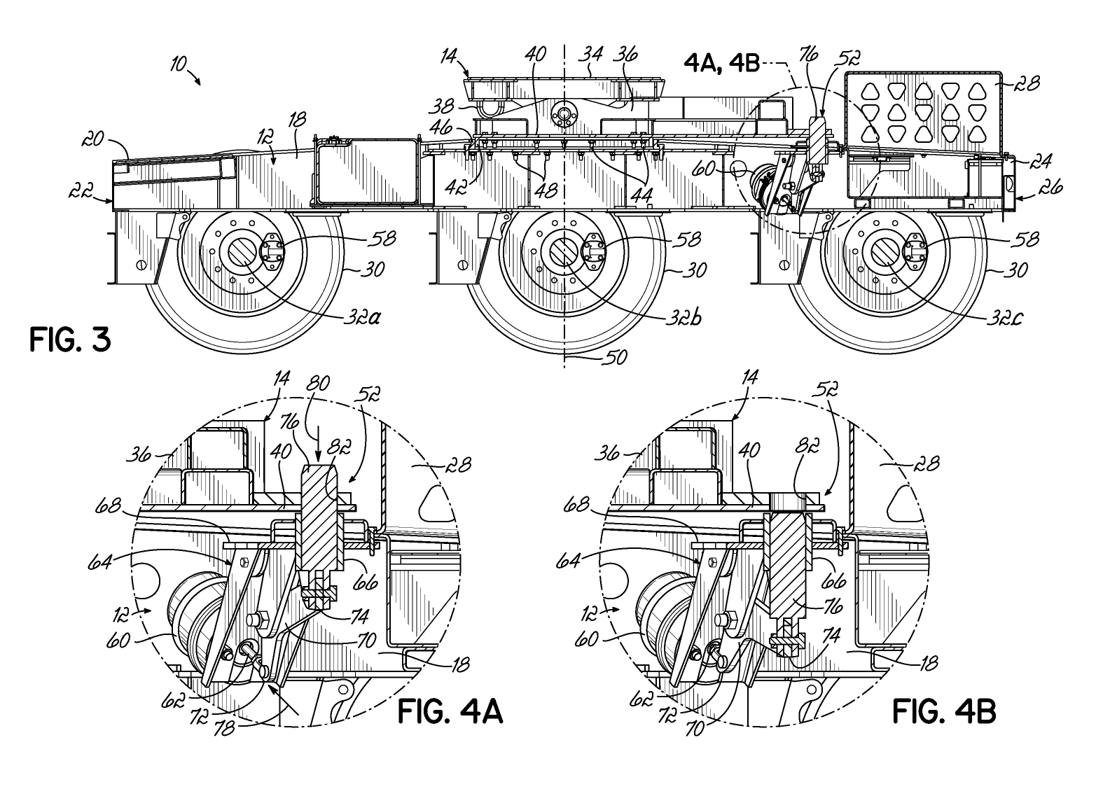

The load deck 14 of the illustrated embodiment is defined by a support bunk 34 and a rotatable platform 36 coupled to the frame 12. The support bunk 34 includes a plurality of tie-off points 38 for attaching straps or belts to secure a load onto the support bunk 34. The support bunk 34 is illustrated as a generally rectangular plate, but it will be appreciated that circular and other types of bunks may be used. As shown most clearly in FIG. 3, the rotatable platform 36 includes a base panel 40 coupled to a generally cylindrical bearing member 42 by a plurality of bolts 44. The generally cylindrical bearing member 42 is rotatably housed in a generally cylindrical receptacle 46 mounted to the frame 12 by a plurality of bolts 48. The bearing member 42 is configured to freely rotate within the cylindrical receptacle 46 about a central vertical axis 50 defined by the bearing member 42 and cylindrical receptacle 46, thereby enabling the load deck 14 to rotate with respect to the frame 12. Thus, the support bunk 34 can be positioned in any appropriate orientation before or during loading of the dolly 10. The frame 12 and load deck 14 also include a locking arrangement 52 for locking the load deck 14 in at least one position, as explained in further detail below.

Again referring to FIGS. 1 and 2, the plurality of axles 32 in the preferred embodiment includes a front axle 32a, a central axle 32b, and a rear axle 32c. It will be appreciated that more or fewer axles 32 and wheels 30 may be provided on the dolly 10 without departing from the scope of this invention. Each of the plurality of axles 32 is coupled to the frame 12 at the first side member 16 and the second side member 18. The axles 32 extend generally transverse to the longitudinal direction and are generally parallel to each other axle 32. The axles 32 may be coupled to both the first and second side members 16, 18 because the axles 32 do not pivot to cause the dolly 10 to turn, as is typical in conventional dollies. Each axle 32 further includes a first end 54 projecting beyond the first side member 16 and a second end 56 projecting beyond the second side member 18. Wheels 30 are mounted on each axle 32 at the first end 54 and the second end 56 and are rotatable with respect to the axle 32. In the illustrated embodiment, the wheels 30 are standard double wheels for supporting heavy loads on the dolly 10, but it will be appreciated that single wheels may be used in alternative embodiments. It will also be appreciated that although a single axle extends across the width of the trailer and has wheels on both ends, separate axles may be used for each of the wheels.

The dolly 10 also includes a plurality of independent drive motors 58 operatively coupled to each wheel 30. Each drive motor 58 may be independently actuated to separately drive the respective wheel 30 the drive motor 58 is coupled with. Therefore, each wheel 30 may be independently driven with respect to every other wheel 30 on the dolly 10. The drive motors 58 are coupled to the axles 32 as shown in the figures, or alternatively, the drive motors 58 may be mounted directly on the first and second side members 16, 18 of the frame 12. The drive motors 58 may be any type of conventional motor operable to drive a wheel 30, including a hydraulic motor or an electric motor, for example. Each of the drive motors 58 is also operatively connected to a control system (not shown) housed within the control box 28 of the dolly 10. In embodiments where the drive motors 58 are hydraulic motors, the control system will include a hydraulic supply pump individually coupled to each of the drive motors 58 to supply pressurized hydraulic fluid to actuate the drive motors 58 as necessary. In embodiments where the drive motors 58 are electrical motors, the control system will include a source of electrical power (i.e., a battery or an internal combustion engine) individually coupled to each of the drive motors 58. Although in the preferred embodiment, separate hydraulic and/or electrical power sources are provided, it will be appreciated that a single hydraulic and/or electrical power source may be used to supply power to the individual drive motors 58. The control system may be operated manually at the control box 28 or remotely using a wireless controller (not shown) that may actuate each of the individual drive motors 58, as is well understood in the art of control systems. The drive motors 58 enable a full range of motion for the dolly 10, as explained in further detail below.

The locking arrangement 52 for preventing relative rotation of the load deck 14 and the frame 12 is further illustrated in FIGS. 3-4B. The locking arrangement 52 includes an actuator 60 configured to move a drive shaft 62 in an axial direction. The actuator 60 is coupled to the second side member 18 of the frame 12. A lock framework 64 is bolted onto the actuator 60 and includes a cylindrical journal bearing 66 disposed in an upper frame plate 68. Below the upper frame plate 68, the lock framework 64 is pivotally coupled to an angled pivot plate 70 having a first pivot end 72 and a second pivot end 74. The first pivot end 72 is coupled to the drive shaft 62 and the second pivot end 74 is coupled to a generally cylindrical locking member 76 disposed through the journal bearing 66 of the upper frame plate 68. Consequently, as the actuator 60 retracts the drive shaft 62 as shown by arrow 78 in FIG. 4A, the pivot plate 70 rotates with respect to the lock framework 64 and forces the locking member 76 downward through the journal bearing 66 as shown by arrow 80 in FIG. 4A. Also shown in FIG. 4A, the rotatable platform 36 of the load deck 14 includes an aperture 82 configured to receive the locking member 76 when the locking member 76 extends upwardly through and beyond the journal bearing 66 in a locked position. FIG. 4B illustrates an unlocked position of the locking member 76 when the actuator 60 causes the locking member 76 to retract out of the aperture 82 in the rotatable platform 36. Thus, the locking arrangement 52 may selectively prevent relative rotation of the load deck 14 and the frame 12 when the locking member 76 is disposed through the aperture 82 in the locked position.

Referring to FIG. 3, the first and second side members 16, 18 of the frame 12 may taper slightly toward the front end 22 and the rear end 26 to provide room for the rotatable platform 36 to rotate above the frame 12 and any attachments of the frame 12, such as the upper frame plate 68 of the locking arrangement 52. In the illustrated embodiment of the dolly 10, the rotatable platform 36 may be freely rotated with respect to the frame 12 by manual force or by rotation of the frame 12 caused by the drive motors 58. It will be understood that a separate conventional drive mechanism may be provided to drive the rotatable platform 36 at the cylindrical bearing member 42. This separate conventional drive mechanism could be controlled manually at the control box 28 or remotely using a wireless controller.

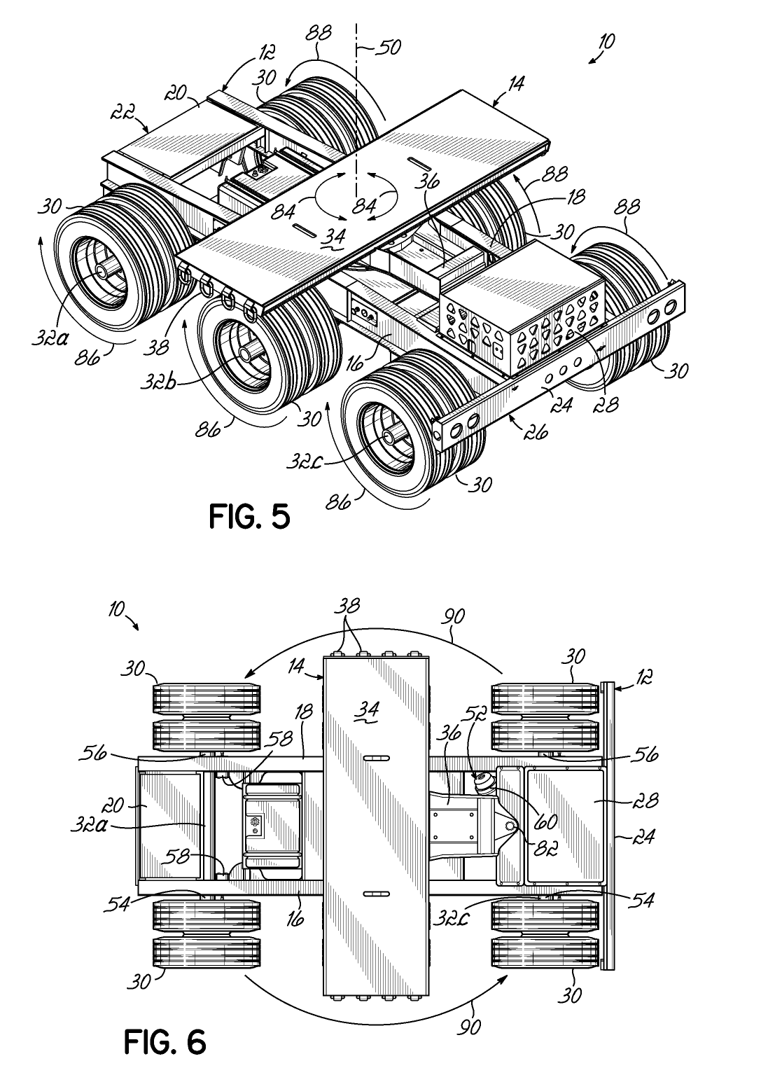

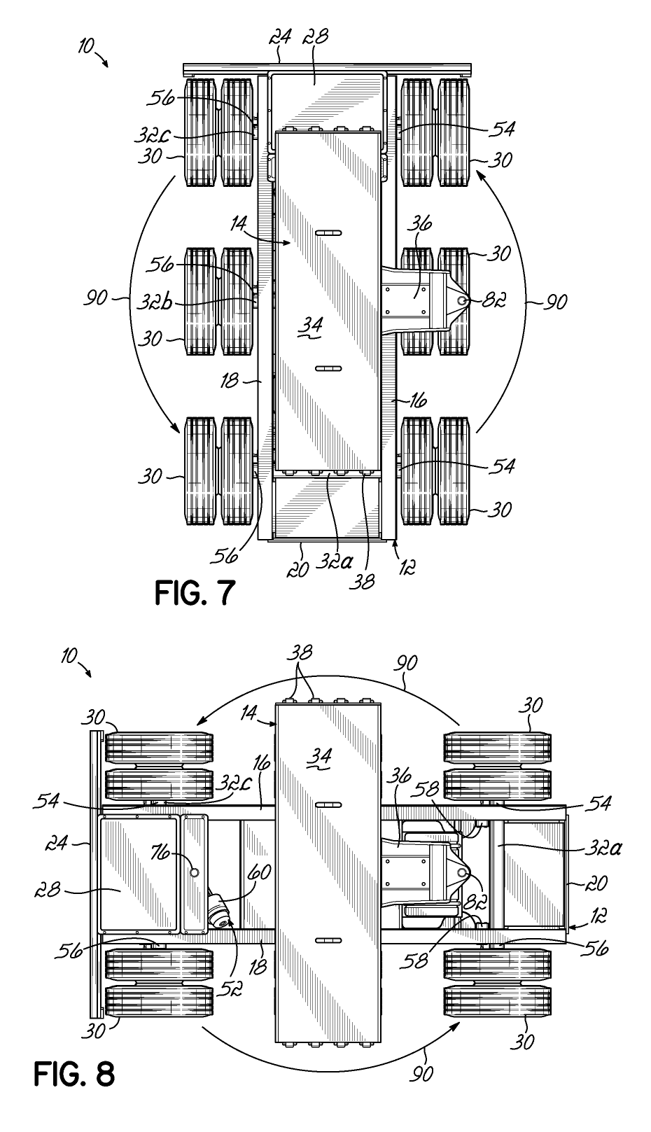

The operation of the dolly 10 is further illustrated in FIGS. 5-8. As discussed above, the independent drive motors 58 enable the control system to actuate each of the wheels 30 to rotate separately. Independent operation of the wheels 30 improves the maneuverability and control of the dolly 10 before, during, and after loading. In one example, the dolly 10 may be turned around the central axle 32b or the central vertical axis 50 as indicated by arrows 84 in FIG. 5. The drive motors 58 at the first ends 54 of the axles 32 are actuated to rotate the corresponding wheels 30 along that side in a first direction indicated by arrows 86, while the drive motors 58 at the second ends 56 of the axles 32 are actuated to rotate the corresponding wheels 30 along the other side in a second direction indicated by arrows 88 and opposite to the first direction. From a first rotational position shown in FIG. 6, this actuation of the drive motors 58 and wheels 30 rotates the frame 12 of the dolly 10 counterclockwise around the central vertical axis 50 when viewed from above (indicated by arrows 90 in FIGS. 6, 7, and 8). Thus, the frame 12 rotates to a second rotational position shown in FIG. 7 and further to a third rotational position shown in FIG. 8. If the load deck 14 is not locked in position by the locking arrangement 52, the frame 12 of the dolly 10 can fully rotate 360 degrees underneath a stationary load on the load deck 14 as shown by FIGS. 6-8. This operation effectively reduces the turning radius of the dolly 10 to zero in tight quarters.

In another exemplary operation, the dolly 10 may be turned using a skid steer turn to minimize a turning radius. In this operation, the drive motors 58 at the first ends 54 of the axles 32 are again actuated to rotate the corresponding wheels 30 along that side in a first direction indicated by arrows 86 in FIG. 5, while the drive motors 58 at the second ends 56 of the axles 32 are not actuated. Thus, the wheels 30 along the first side member 16 turn the dolly 10 while the wheels 30 along the second side member 18 remain stationary. Like the previously-described operation, turning the dolly 10 in the “skid steer” fashion also minimizes a turning radius of the dolly. It will be appreciated that the control system could actuate different combinations of the drive motors 58 for even further operations that are not currently possible with conventional dollies.

In summary, the dolly 10 of the present invention includes independent drive motors 58 configured to separately drive each wheel 30 on various axles 32 of the dolly 10. This independent actuation enables turning operations of the dolly 10 with a minimized turning radius as well as other advantages. The dolly 10 also includes a locking arrangement 52 that selectively prevents relative rotation of the load deck 14 from the frame 12, such that the drive motors 58 can be actuated in an unlocked state of the locking arrangement 52 to rotate the frame 12 with respect to the load deck 14. The dolly 10 therefore can be used in smaller spaces and for more applications than conventional dollies.

While the present invention has been illustrated by the description of the embodiment thereof, and while the embodiment has been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A dolly comprising:
a frame for supporting a load; the frame having a left side and a right side;
a plurality of axles coupled to the frame so as to be generally parallel to one another;
a wheel rotationally coupled to each of the plurality of axles; and
drive motors operatively connected to each of the wheels, wherein the drive motors rotate the wheels independently from each other.

2. The dolly of claim 1, wherein the frame includes a load deck rotatably coupled to the frame such that the frame can rotate with respect to the load deck.

3. The dolly of claim 2, wherein the load deck is rotatably coupled to the frame by a rotatable platform, and the method further comprises:
a locking arrangement for the load deck including an aperture in the rotatable platform and a locking member coupled to the frame and configured to engage the aperture in the rotatable platform to prevent relative rotation of the frame and the load deck.

4. The dolly of claim 1, further comprising:
a control system operatively coupled to each of the drive motors and configured to actuate the drive motors alone or in combination.

5. The dolly of claim 4, wherein the control system is adapted to actuate the drive motors along the left or right side of the frame in one direction simultaneously while the drive motors along the opposite side of the frame are unactuated such that the dolly is turned by the wheels along the left or right side of the frame while the wheels along the opposite side of the frame remain stationary.

6. The dolly of claim 4, wherein the control system is adapted to actuate the drive motors along the left side of the frame simultaneously in a first direction while actuating the drive motors along the right side of the frame in a second direction opposite to the first direction, thereby turning the dolly about a vertical axis through the frame.

7. The dolly of claim 4, wherein the drive motors are electrical motors, and the control system includes a source of electrical power to be delivered to each of the drive motors individually.

8. The dolly of claim 4, wherein the drive motors are hydraulic motors, and the control system includes a hydraulic supply pump individually coupled to each of the hydraulic motors.

9. The dolly of claim 4, wherein the control system includes a wireless controller configured to remotely actuate each of the drive motors.

10. A method of steering a dolly having a frame with a left side and right side, a plurality of axles, and a wheel rotatably coupled to each of the plurality of axles, the method comprising:
coupling a drive motor to each of the wheels; and
actuating the drive motors to drive at least one of the wheels of the dolly independently from the other wheels.

11. The method of claim 10, wherein the dolly further includes a load deck rotatably coupled to the frame, the method further comprising:
actuating the drive motors to rotate the frame with respect to the load deck.

12. The method of claim 10, wherein the drive motors are electric motors, and actuating the drive motors includes independently delivering electrical power to each of the drive motors.

13. The method of claim 10, wherein the drive motors are hydraulic motors, and actuating the drive motors includes independently delivering hydraulic fluid from an individual hydraulic supply pump to each of the drive motors.

14. The method of claim 10, further comprising:
actuating the drive motors along the left or right side of the frame in one direction simultaneously while the drive motors along the opposite side are unactuated such that the dolly is turned by the wheels along the left or right side of the frame while the wheels along the opposite side of the frame remain stationary.

15. The method of claim 10, further comprising:
actuating the drive motors along the left side of the frame simultaneously in a first direction; and
actuating the drive motors along the right side of the frame in a second direction opposite to the first direction, thereby turning the dolly about a vertical axis through the frame.
